(19) United States
(12) Patent Application Publication
(10) Pub. No.: US 2010/0329571 A1
(43) Pub. Date: Dec. 30, 2010

(54) SHAPE BASED REGISTRATION

(75) Inventors: Navneeth Subramanian, Bangalore (IN); Jerome Francois Knoplioch, Buc (FR); Eric Pichon, Buc (FR)

Correspondence Address: GENERAL ELECTRIC COMPANY;GLOBAL RESEARCH, ONE RESEARCH CIRCLE, BLDG. K1-3A59, NISKAYUNA, NY, 12309, US

(73) Assignee: General Electric Company, Schenectady, NY (US)

(21) Appl. No.: 12/490,675

(22) Filed: Jun. 24, 2009

(51) Int. Cl. G06K 9/46

(52) U.S. Cl. 382/203

(57) ABSTRACT

A method for registering a source image of an object with a target image of the object includes generating a mask image delineating a structure of interest from the source image, determining a distance map for the mask image, determining a shape representation by identifying an iso-value on the distance map such that level curves correspond to the characteristics of a desired shape, iteratively calculating a similarity metric corresponding to a region of overlap between the level curve based shape representation and the second image resulting in a registration transform, applying the registration transform to the target image to co-register the source image with the target image, and displaying the co-registered source image and the target image on a display device.

### BACKGROUND

Embodiments of the invention relate generally to shape based registration. More particularly, embodiments of the invention relate to a system and method for performing image registration using shape information to improve registration quality.

A majority of the methods for image registration, in widespread use operate primarily on the image intensities. These methods have been shown to have a tendency to be misled by local optima. Their limitations are further amplified when one is presented with images from different modalities with different FOV's (as is typical in interventional applications). In such scenarios, registration using existing algorithms is challenging. The inadequacy of these algorithms can be attributed to the lack of anatomical intelligence or shape priors in these algorithms.

Intensity based algorithms, such as mutual information, are used widely. These algorithms have been shown to have limitations for image pairs with partial overlap and FOV differences. Moreover, they do not take spatial information into account. Landmark based algorithms, on the other hand can be very cumbersome from the workflow perspective, as the user has to manually specify landmark correspondences. In several situations, such as interventional applications, this may be infeasible. Further, existing approaches (landmark, PCA based) are highly time- consuming and require explicit point correspondence.

It is desirable that a method for performing image registration be provided that does not require explicit specification of landmarks.

### BRIEF DESCRIPTION

In one embodiment, a method for registering a source image of an object with a target image of the object is provided. The method includes generating a mask image delineating a structure of interest from the source image, determining a distance map for the mask image, determining a shape representation, by identifying an iso-value on the distance map such that level curves correspond to the characteristics of a desired shape, iteratively calculating a similarity metric corresponding to a region of overlap between the level curve based shape representation and the second image resulting in a registration transform, applying the registration transform to the target image to co-register the source image with the target image; and displaying the co-registered source image and the target image on a display device.

In another embodiment, an image registration system for registering a source image of an object with a target image of the object is provided. The system includes a segmentation mask generator to generate a mask image delineating a structure of interest from a source image, to determine a distance map for the mask image, and to determine a shape representation, by identifying an iso-value on the distance map such that level curves correspond to the characteristics of a desired shape. The system further includes a similarity measure calculator to calculate a similarity metric corresponding to a region of overlap between the level curve based shape and the second image resulting in a registration transform and to apply the registration transform to the target image to co-register the source image with the target image. The system further includes a display device to display the co-registered source image and target image.

In yet another embodiment, an apparatus comprising a machine readable medium is presented. The machine readable medium having instructions stored therein which, when executed by a processor, cause the apparatus to generate a mask image delineating a structure of interest from a source image, determine a distance map for the mask image, determine a shape representation, by identifying an iso-value on the distance map such that level curves correspond to the characteristics of a desired shape, iteratively calculate a similarity metric corresponding to a region of overlap between the level curve based shape representation and a target image resulting in a registration transform, apply the registration transform to the target image to co-register the source image with the target image, and display the co-registered source image and target image on a display device.

### DRAWINGS

These and other features, aspects, and advantages of the present invention will become better understood when the following detailed description is read with reference to the accompanying drawings in which like characters represent like parts throughout the drawings, wherein:

FIG. 1 is an image illustrating the ability of a distance map to capture global shape characteristics while ignoring local variations, in accordance with one embodiment of the invention;

FIG. 2 illustrates the effect of the parameter Lambda on the shape of the modified mask used for similarity metric computation, in accordance with one embodiment of the invention;

FIG. 3 illustrates a schematic of a shape-based registration method in accordance with one embodiment;

FIG. 4 illustrates one embodiment of an image registration subsystem for performing the shape-based registration method of FIG. 3;

FIG. 5 illustrates shape based registration positioning in accordance with one embodiment of the invention; and

FIG. 6 illustrates an assessment of registration quality using thin MIP's in accordance with one embodiment of the invention.

### DETAILED DESCRIPTION

In the following detailed description, numerous specific details are set forth in order to provide a thorough understanding of various embodiments of the present invention. However, those skilled in the art will understand that embodiments of the present invention may be practiced without these specific details, that the present invention is not limited to the depicted embodiments, and that the present invention may be practiced in a variety of alternative embodiments. In other instances, well known methods, procedures, and components have not been described in detail.

Some portions of the detailed description that follows are presented in terms of algorithms, programs and/or symbolic representations of operations on data bits or binary digital signals within a computer memory, for example. These algorithmic descriptions and/or representations may include techniques used in the data processing arts to convey the arrangement of a computer system and/or other information handling system to operate according to such programs, algorithms, and/or symbolic representations of operations.

An algorithm may be generally considered to be a self-consistent sequence of acts and/or operations leading to a desired result. These include physical manipulations of physical quantities. Usually, though not necessarily, these quantities take the form of electrical and/or magnetic signals capable of being stored, transferred, combined, compared, and/or otherwise manipulated. It has proven convenient at times, principally for reasons of common usage, to refer to these signals as bits, values, elements, symbols, characters, terms, numbers and/or the like. It should be understood, however, that all of these and/or similar terms are to be associated with the appropriate physical quantities and are merely convenient labels applied to these quantities.

Unless specifically stated otherwise, as apparent from the following discussions, it is appreciated that throughout the specification discussion utilizing terms such as processing, computing, calculating, determining, and the like, refer to the action and/or processes of a computer or computing system, or similar electronic computing device, that manipulates or transforms data represented as physical, such as electronic, quantities within the registers and/or memories of the computer or computing system and similar electronic or computing device into other data similarly represented as physical quantities within the memories, registers or other such information storage, transmission and display devices of the computing system and/or other information handling system.

The processes and/or displays presented herein are not inherently related to any particular computing device and/or other apparatus. Various general purpose systems may be used with programs in accordance with the teachings herein, or it may prove convenient to construct a more specialized apparatus to perform the desired method. The desired structure for a variety of these systems will appear from the description below. In addition, embodiments are not described with reference to any particular programming language. It will be appreciated that a variety of programming languages may be used to implement the teachings described herein.

In one embodiment of the invention, methods, programs, algorithms, and/or symbolic representations of operations described herein are implemented as a component or part of an imaging system. In one embodiment, such imaging systems may include digital x-ray systems, computed tomography (CT) systems, ultrasound and magnetic resonance (MR) systems. In one embodiment, such programs, algorithms, and/or symbolic representations of operations are implemented as an automated workflow application within an imaging system.

In the following description, various operations may be described as multiple discrete steps performed in a manner that is helpful for understanding embodiments of the present invention. However, the order of description should not be construed as to imply that these operations need be performed in the order they are presented, nor that they are even order dependent. Moreover, repeated usage of the phrase “in one embodiment” does not necessarily refer to the same embodiment, although it may. Lastly, the terms “comprising”, “including”, “having”, and the like, as well as their inflected forms as used in the present application, are intended to be synonymous unless otherwise indicated.

In accordance with one embodiment a system and method for performing image registration is provided that does not require explicit specification of landmarks, but utilizes shape information of target anatomy to improve registration quality. There is an especially strong case for shape priors in medical imaging, as there is a wealth of clinical knowledge of anatomy (e.g., organ, vessel level) that goes unused in current registration algorithms. Shape information allows the focus on the anatomy of interest in situations where interventional devices (e.g., catheters, etc.) have caused changes to the treatment site, as is typical in liver interventions. In accordance with embodiments of the invention, a system and method for fully automatic registration of three-dimensional (3D) images including X-ray images, CT images, ultrasound images and MR images is described. In one embodiment, fully automatic registration of a liver for treatment planning in liver interventions is described.

In accordance with one embodiment, a general registration method comprises a source image or scan and a target image or scan, and a similarity measure (also referred to as a cost-function). In one embodiment, the source image may be considered a fixed image and the target image may be considered a moving or non- fixed image. An optimized transformation that maximizes the similarity measure between the source and the target image is determined. As a result, any point on the source image can be associated with its corresponding point on the target image by applying the transformation.

Vessel Mask Generation

In one embodiment, a binary mask delineating the structure of interest is first generated. This mask can be generated using existing segmentation methods applied on the source image (fixed image). Alternatively, the mask may be generated by averaging representations of the target structure across several scans or through the use of a digital atlas. A distance map of the mask image is then determined using either the Euclidean distance metric or the city block distance metric, for example.

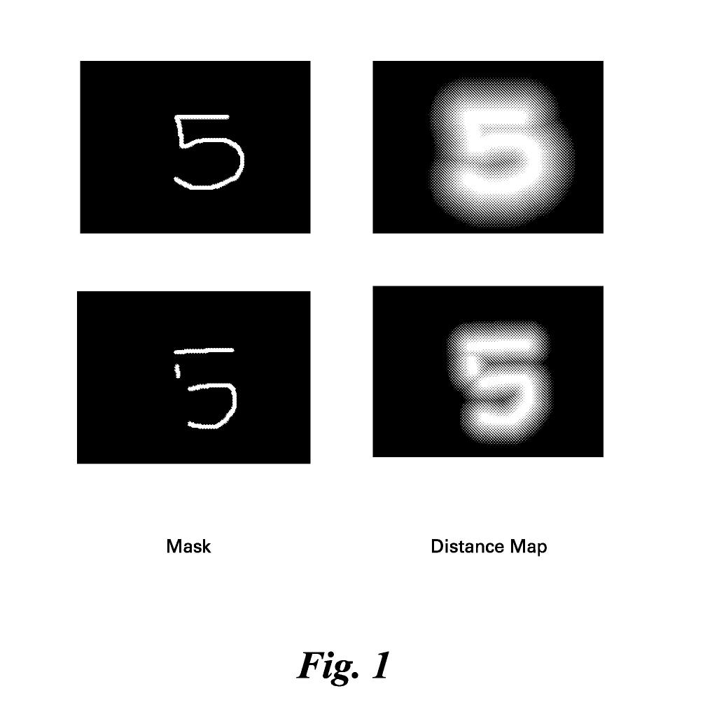

FIG. 1 illustrates the ability of the distance map to capture global shape characteristics while ignoring local variations, in accordance with one embodiment of the invention. More specifically, column (a) of FIG. 1 illustrates the two writings of the numeral 5 differing geometrically and in connectivity. However, their distance map transforms (illustrated in column (b)) are nonetheless very similar.

In one embodiment, an iso-value is selected on the distance map such that the level curves (or surface) corresponding to this iso-value appropriately capture the characteristics of the desired shape. This level curve allows one to increase the capture range of the cost-function (see FIG. 1). In addition the level curve also allows for a multi-resolution registration where one can tune the algorithm to capture global- local shape variations.

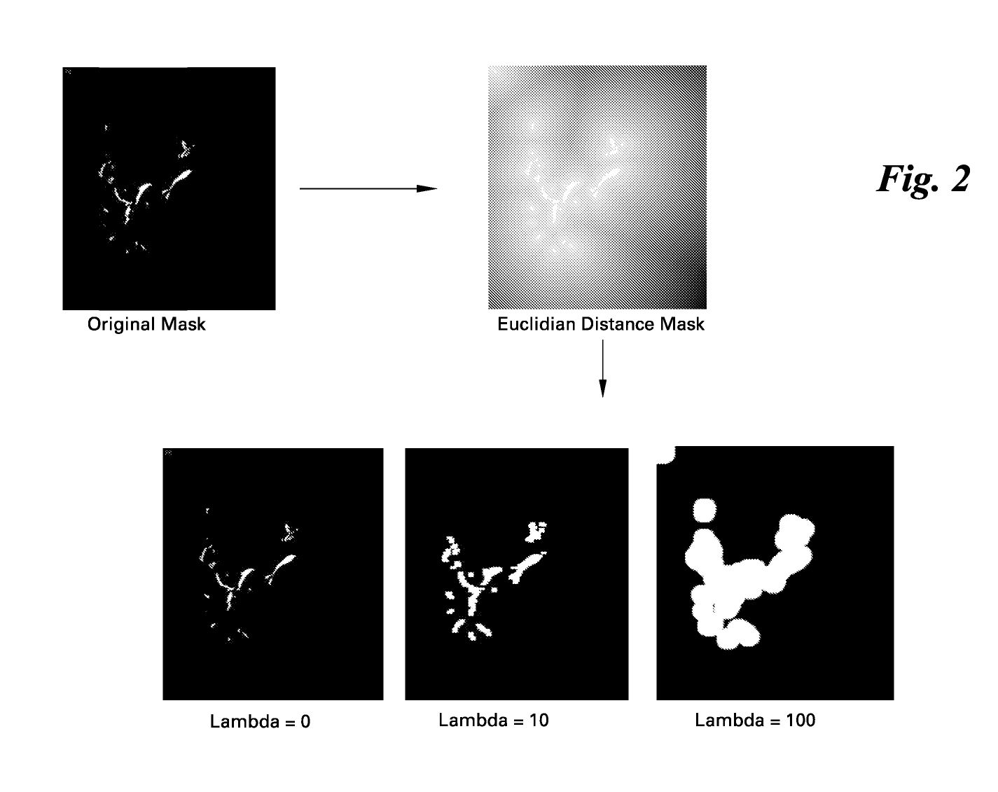

FIG. 2 illustrates the effect of an iso-value (e.g., the parameter Lambda) on the shape of the modified mask used for similarity metric computation, in accordance with one embodiment of the invention. By increasing Lambda, it is possible to focus on local shape characteristics rather than global shape characteristics. Increasing lambda also increases the capture range of the similarity metric.

Shape Similarity Metrics

Formally, given a mask X and its distance map EDT(X), a new mask Ω can be generated by selecting an iso-value λ for which:

Ω={EDT(X)<λ} (1)

In one embodiment, a similarity metric (cost-function) is computed corresponding to the region of overlap of the level-curve (or surface) previously extracted and the target image. The level curve (or surface) serves as an effective way to constrain computation and to speed up the registration. If the mask region is denoted by Ω, and fixed or source image as F, the moving or target image as M, then the similarity metric denoted by D(F,M) can be any of the following:

Product of intensities: This similarity metric captures co-occurrences of bright pixels and is applicable to objects with contrast injection. It may be defined as:

$$\begin{matrix}D ( F , M ) = {\sum }_{i = 1}^{n} I ( M , {X}_{i} ) I ( F , {X}_{i} ) & ∀ {X}_{i} ∈ Ω \\ D ( F , M ) = 0 & ∀ {X}_{i} ∉ Ω \\ Where the mask , & \\ Ω = \{ EDT ( X ) < λ \} & \end{matrix} \qquad ( 2 )$$

Mutual Information:

$$\begin{matrix}D ( F , M ) = \begin{matrix}{\sum }_{i = 1}^{n} {P}_{F , M} ( F , M , {X}_{i} ) \\ log \frac{{P}_{F , M} ( F , M , {X}_{i} )}{{P}_{F} ( F , {X}_{i} ) {P}_{M} ( M , {X}_{i} )}\end{matrix} & ∀ {X}_{i} ∈ Ω \\ D ( F , M ) = 0 & ∀ {X}_{i} ∉ Ω \\ Where the mask , & \\ Ω = \{ EDT ( X ) < λ \} & \end{matrix} \qquad ( 3 )$$

Where, P_{F}(F, M, Xᵢ) and P_{F}(F, M, Xᵢ) are the marginal probability distribution and P_{F,M}(F, M, Xᵢ) is the joint probability distribution.

Medial axis based: In this similarity metric the medial axis of the shape is given highest preference for alignment. The parameter α controls the weightage given to the medial axis. High values of alpha disregard pixels that do not belong to the medial axis.

$$\begin{matrix}D ( F , M ) = {\sum }_{i = 1}^{n} {e}^{- α I ( F , {X}_{i} )} I ( M , {X}_{i} ) I ( F , {X}_{i} ) & ∀ {X}_{i} ∈ Ω \\ D ( F , M ) = 0 & ∀ {X}_{i} ∉ Ω \\ Where the mask , & \\ Ω = \{ EDT ( X ) < λ \} & \end{matrix} \qquad ( 4 )$$

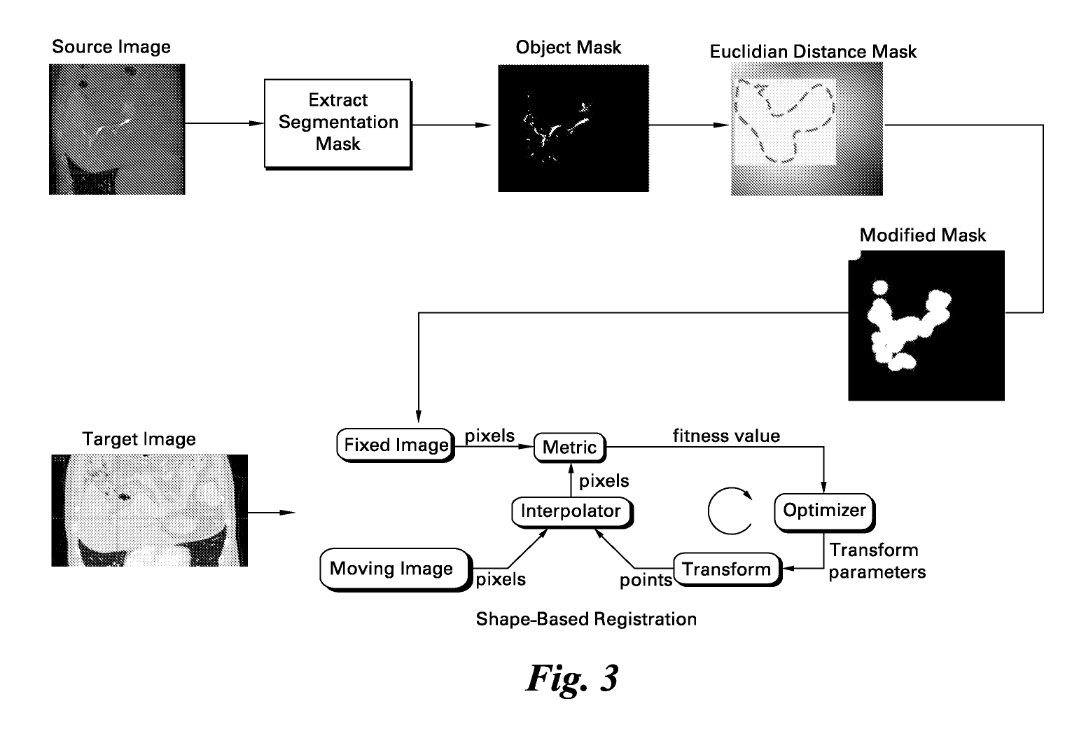

FIG. 3 illustrates a schematic of a shape-based registration method in accordance with one embodiment. In the first step, a coarse segmentation of the structure of interest is generated from one of the datasets forming a segmentation mask. In a next step, a Euclidean distance map 32 of this segmentation mask is computed and an iso-value (e.g., lambda) is selected to capture the shape of the desired structure forming a modified mask 34. The desired structure may be a vessel or organ but need not be limited as such. This image is then input into an optimization processor that iteratively computes the optimal transformation such that the similarity metric (as illustrated by equation 2) is minimized. The resulting transformation has the technical effect of co-registering the source image onto the target image. In one embodiment, the transformation can be a rigid transform (e.g., affine) or a non-rigid transformation (e.g., B-Spline). Moreover, the source image can be generated from a segmentation algorithm applied on an image or from a digital atlas, for example.

The shape-based registration method of FIG. 3 may be implemented in software or hardware and may comprise a variety of apparatuses for performing the operations described herein. These apparatus may be specially constructed for the desired purposes for performing the shape-based registration method, or it may comprise a general purpose computing device selectively activated and/or reconfigured by a program stored in the device to perform the method. Such a program may be stored on a storage medium, such as, but is not limited to, any type of disk including floppy disks, optical disks, CD-ROMs, magnetic-optical disks, read- only memories (ROMs), random access memories (RAMs), electrically programmable read-only memories (EPROMs), electrically erasable and/or programmable read only memories (EEPROMs), flash memory, magnetic and/or optical cards, and/or any other type of media suitable for storing electronic instructions, and/or capable of being coupled to a system bus for a computing device and/or other information handling system.

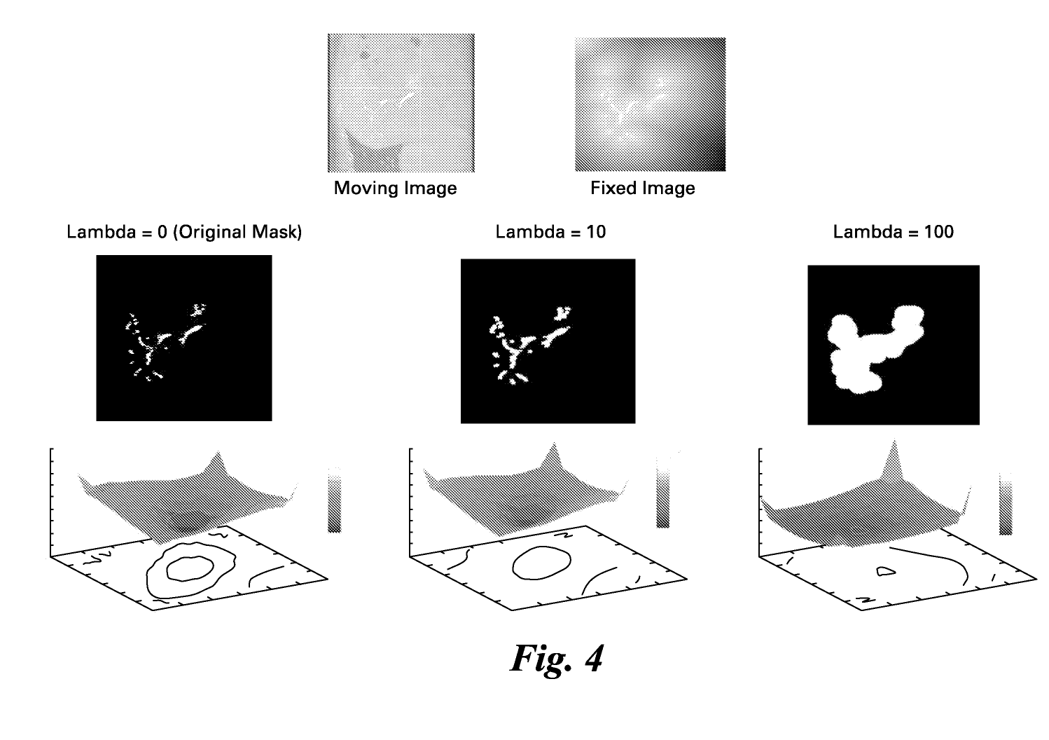

FIG. 4 illustrates one embodiment of an image registration subsystem for performing the shape-based registration method of FIG. 3. In one embodiment, the shape-based image registration subsystem may be part of a general-purpose computer to which 3D images from a scanner are sent for computation of the registration. The 3D images may include, but are not limited to a 3D XA scan, a 3D CT scan, a 3D ultrasound scan and a 3D MR scan. As illustrated in FIG. 4, image registration subsystem 40 includes a segmentation mask generator 42 and a similarity measure calculator 44 communicatively coupled. In one embodiment, the segmentation mask generator 42 and the similarity measure calculator 44 may be dedicated hardware components coupled to each other. In another embodiment, the segmentation mask generator 42 and the similarity measure calculator 44 may be software components configured to receive and pass one or more variables or expressions to one or more other components. In one embodiment, the segmentation mask generator 42 is configured to receive a first, fixed source image from a source such as an image scanner 46, and generate a segmentation mask. The segmentation mask generator 42 may further determine a distance map for the mask image and determine a shape representation by identifying an iso-value on the distance map such that level curves correspond to the characteristics of a desired shape. In one embodiment, the similarity measure calculator 44 is configured to receive a second, moving or target image and iteratively calculate a similarity metric corresponding to a region of overlap between the level curve based shape and the source image, resulting in a registration transform 47. The registration transform 47 may then be applied to the target image 48 to co-register the source image with the target image. The co-registered pair of images is then displayed on display device 49 for viewing.

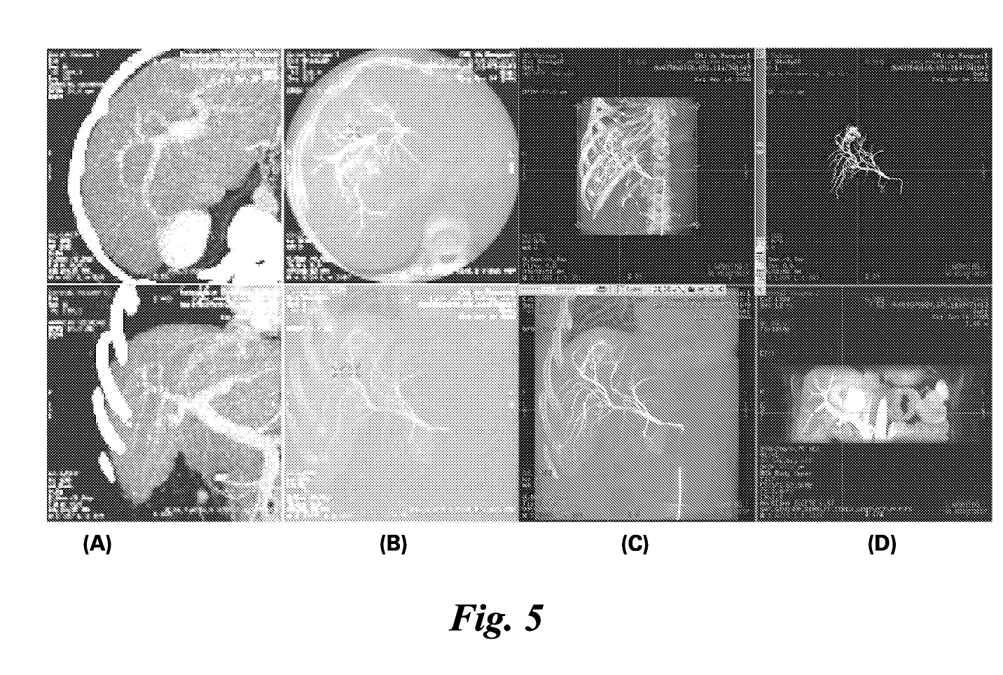

FIG. 5 illustrates shape based registration positioning in accordance with one embodiment of the invention. More specifically, FIG. 4 illustrates a metric response surface for a translation of −30, 30 mm along X and Y axes. This figure illustrates how the shape based registration is accurately able to position the minima at (0,0) which the optimal location for the shape used. Increasing the lambda parameter helps increase the capture range of the similarity metric.

Experiments and Results

Computed Tomography angiography (CTA) and Rotational Angiography studies of the liver of 9 patients planned for chemoembolization for hepatocellular carcinoma were obtained. All CT examinations were acquired with a 4-slice multidetector-row CT (pixel size: 0.3×0.3 mm, thickness 0.625 mm). Rotational Angiography studies had been acquired intra-operatively with the Flat Panel Digital Angiography system (pixel size 0.3×0.3 mm). Co-registrations of the CT and Rotational Angiography studies of each patient were automatically performed using the shape based registration method. The distance between 4 corresponding landmarks on the CTA and Rotational Angiography was then manually determined. The mean of these errors was calculated to give an overall indication of the registration error.

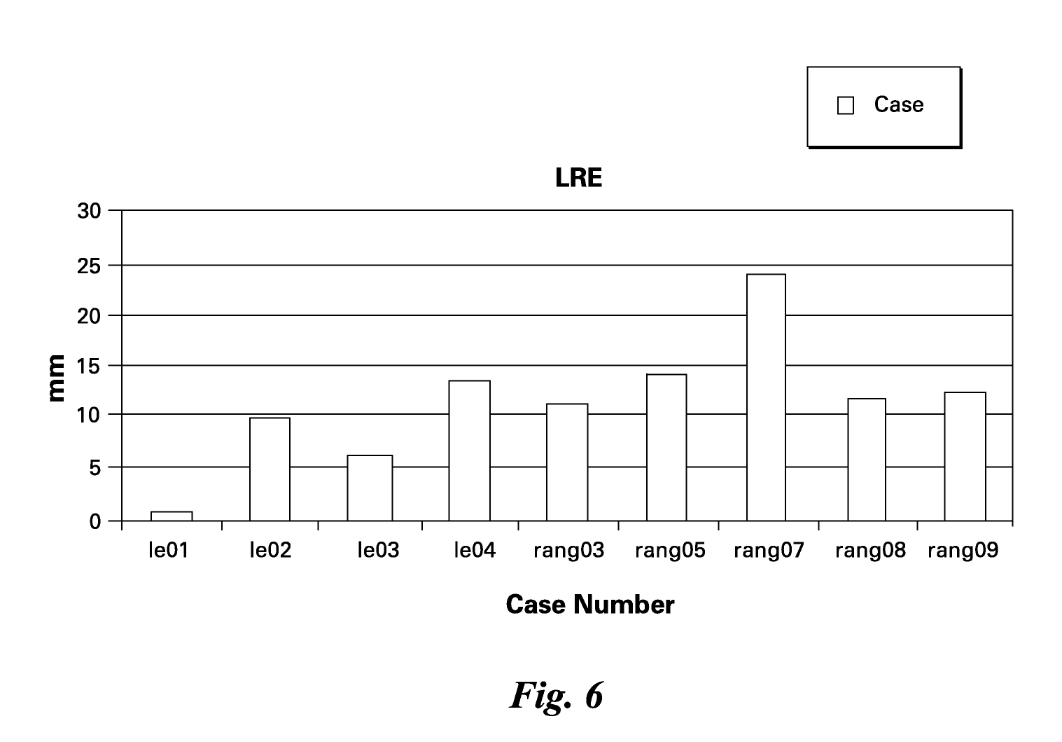

FIG. 6 illustrates an assessment of registration quality using thin MIP's. Columns (a) and (b) illustrate registration of CTA (column a) with 3D x-ray angiography (XA) (column b) utilizing the methods described herein. Columns (c) and (d) illustrate registration of 3D XA (column C) to MR LAVA scan (column d) utilizing the methods described herein. In both cases, the correspondence of vascular landmarks in the hepatic system is illustrated.

Aspects of the invention include the utilization of shape based features to effectively register scans without a dependency on intensity or gradient alone. This has tremendous potential as it allows one to use a wealth of clinical knowledge of anatomy explicitly in an image registration algorithm. Automated co-registration of CTA to Rotational Angiography studies of the liver can be performed allowing multimodality fusion of hepatic cellular carcinoma. Potential applications include generating an angiographic roadmap from a prior CTA data for planning chemoembolization for liver; reduction of contrast dose and radiation dose, especially during catheter navigation in difficult anatomy and 3D augmentation of fluoroscopy.

While only certain features of the invention have been illustrated and described herein, many modifications and changes will occur to those skilled in the art. It is, therefore, to be understood that the appended claims are intended to cover all such modifications and changes as fall within the true spirit of the invention.

What is claimed is:

1. A method for registering a source image of an object with a target image of the object, the method comprising:
generating a mask image delineating a structure of interest from the source image;
determining a distance map for the mask image;
determining a shape representation, by identifying an iso-value on the distance map such that level curves correspond to the characteristics of a desired shape;
iteratively calculating a similarity metric corresponding to a region of overlap between the level curve based shape representation and the second image resulting in a registration transform;
applying the registration transform to the target image to co-register the source image with the target image; and
displaying the co-registered source image and the target image on a display device.

2. The method of claim 1, wherein the similarity metric comprises a product of intensities within the level curves of the shape representation.

3. The method of claim 1, wherein the similarity metric is weighted based on distance from a medial axis of the shape.

4. The method of claim 1, wherein the similarity metric comprises mutual information computed within the level curves of the shape representation.

5. The method of claim 1, wherein the similarity measure allows the capture of shape in the image without specification of landmarks and their correspondence.

6. An image registration system for registering a source image of an object with a target image of the object, the system comprising:
a segmentation mask generator to generate a mask image delineating a structure of interest from a source image, determine a distance map for the mask image, and determine a shape representation, by identifying an iso-value on the distance map such that level curves correspond to the characteristics of a desired shape;
a similarity measure calculator to calculate a similarity metric corresponding to a region of overlap between the level curve based shape and the second image resulting in a registration transform, and to apply the registration transform to the target image to co-register the source image with the target image; and
a display device to display the co-registered source image and target image.

7. The system of claim 6, wherein the similarity metric comprises a product of intensities within the level curves of the shape representation.

8. The system of claim 6, wherein the similarity metric is weighted based on distance from a medial axis of the shape.

9. The system of claim 6, wherein the similarity metric comprises mutual information computed within the level curves of the shape representation.

10. The system of claim 6, wherein the similarity measure allows the capture of shape in the image without specification of landmarks and their correspondence.

11. A machine readable medium having instructions stored therein which, when executed by one or more processors, cause the one or more processor to:
generate a mask image delineating a structure of interest from a source image,
determine a distance map for the mask image,
determine a shape representation, by identifying an iso-value on the distance map such that level curves correspond to the characteristics of a desired shape,
iteratively calculate a similarity metric corresponding to a region of overlap between the level curve based shape representation and a target image resulting in a registration transform,
apply the registration transform to the target image to co-register the source image with the target image, and
display the co-registered source image and target image.
